(19) United States
(12) Patent Application Publication
(10) Pub. No.: US 2026/0069968 A1
(43) Pub. Date: Mar. 12, 2026

(54) INTERACTIVE GAME PORTABLE SYSTEM AND CONNECTION ASSEMBLY

(71) Applicant: LÜ-AIRE DE JEU INTERACTIVE INC., Québec (CA)

(72) Inventors: Vincent Routhier, Québec (CA); Pierre Primeau, Québec (CA); Marie Mérouze, Québec (CA); Patrick St-Pierre, Québec (CA); Yannick Chartrand, Québec (CA)

(73) Assignee: LÜ-AIRE DE JEU INTERACTIVE INC., Québec (CA)

(21) Appl. No.: 19/274,046

(22) Filed: Jul. 18, 2025

Related U.S. Application Data
(60) Provisional application No. 63/693,341, filed on Sep. 11, 2024.

(30) Foreign Application Priority Data
Dec. 19, 2024 (DE) 202024107433.5

(51) Int. Cl. A63F 13/27; A63F 13/218; A63F 13/24; F16M 11/28; G03B 21/14

(52) U.S. Cl. CPC A63F 13/27; A63F 13/218; A63F 13/24; F16M 11/28; G03B 21/145

(57) ABSTRACT

An interactive game portable unit comprising: a base including an extendable shaft protruding therefrom and configurable between a compacted configuration and an extended configuration; and a projection head mounted to a distal end of the extendable shaft and translatable therewith. There is also provided a connection assembly between a base including an extendable shaft and a head detachably securable to an end of the extendable shaft.

### CROSS-REFERENCE TO RELATED APPLICATIONS

This application claims priority of U.S. provisional patent application 63/693,341 filed Sep. 11, 2024, and DE20 2024 107 433.5 filed Dec. 19, 2024, the specifications of which are hereby incorporated by reference.

### TECHNICAL FIELD OF THE INVENTION

The technical field relates to the field of interactive games and a connection assembly between a base and a head. More particularly, it relates to a portable interactive game system which allows a room, or a large portion of a room, to be used as a setup for an interactive game, including at least one section of a wall being used as an interactive surface in the interactive game, and a method of operation for same.

### BACKGROUND

Interactive game systems are known, such as Lü® interactive playground and Neo-One™, wherein users can play various activities by using body parts or real-world elements. These systems are typically mounted to a ceiling and project on a wall surface and/or a floor.

These systems are hardly portable in that they cannot easily and quickly be displaced from one location to another.

In view of the above, there is a need for an improved interactive game system and method of operation thereof which would be able to overcome, or at least minimize, some of the above-discussed prior art concerns.

### BRIEF SUMMARY OF THE INVENTION

It is therefore an aim of the present invention to address the above-mentioned issues.

According to a general aspect, there is provided an interactive game portable unit comprising: a base including an extendable shaft protruding therefrom and configurable between a compacted configuration and an extended configuration; a projection head mounted to a distal end of the extendable shaft and translatable therewith; and a pneumatic actuator operatively connected to the extendable shaft and activable to configure the extendable shaft between the compacted configuration and the extended configuration.

According to another general aspect, there is provided an interactive game portable unit comprising: a base including an extendable shaft protruding therefrom and configurable between a compacted configuration and an extended configuration, the base comprising a central unit and a plurality of deployable legs mounted to the central unit, the deployable legs being selectively configurable in a compacted configuration and a deployed configuration, wherein, in the compacted configuration of the deployable legs, the base is supported on a floor at least partially by the central unit and, in the deployed configuration of the deployable legs, the base is supported on the floor by the deployable legs with the central unit being spaced-apart from the floor; and a projection head mounted to a distal end of the extendable shaft and translatable therewith.

According to a further general aspect, there is provided an interactive game portable unit comprising: a base including an extendable shaft protruding therefrom and configurable between configuration and an extended configuration; a projection head mounted to a distal end of the extendable shaft and translatable therewith; and a sound module comprising a low frequency sub-module located in the base and a high frequency sub-module located in the projection head.

According to a still another general aspect, there is provided an interactive game portable unit comprising: a base including an extendable shaft protruding therefrom and configurable between a compacted configuration and an extended configuration; a projection head mounted to a distal end of the extendable shaft and translatable therewith; and a connector sleeve containing and surrounding a plurality of cables extending between the projection head and the base.

According to a general aspect, there is provided an interactive game portable unit comprising:
a base including an extendable shaft translatable between a compacted configuration and an extended configuration wherein the extendable shaft extends outwardly;
a projection head mounted to a distal end of the extendable shaft and translatable therewith; and
a pneumatic actuator operatively connected to the extendable shaft and activable to configure the extendable shaft between the compacted configuration and the extended configuration.

In an embodiment, the base comprises a central unit defining a chamber and the pneumatic actuator is at least partially contained in the chamber.

In an embodiment, the pneumatic actuator comprises an air compressor.

In an embodiment, the extendable shaft is a telescopic shaft.

In the extended configuration of the extendable shaft, a length of the extendable shaft protruding outwardly of the central unit can be longer than a height of the central unit.

In an embodiment, the projection head comprises a coupling receiving recess and the interactive game portable unit further comprises a head engaging coupling mounted to the distal end of the extendable shaft and engageable in the coupling receiving recess to detachably mount the projection head to the distal end of the extendable shaft. Each one of the coupling receiving recess and the head engaging coupling can comprise an insertion section having a tapered profile and a coupling section wider than the coupling section. The projection head can comprise function connectors and/or function ports exposed in the coupling receiving recess and the head engaging coupling can comprise function connectors and/or function ports complementary to and couplable with the function connectors and/or function ports of the projection head when the head engaging coupling is inserted in the coupling receiving recess of the projection head. The head engaging coupling can further comprise a function connector support having the function connectors and/or function ports mounted thereto and the function connector support can be selectively configurable in a raised configuration and a lowered configuration, wherein, when the head engaging coupling is inserted in the coupling receiving recess of the projection head and the function connector support is configured in the raised configuration, the function connectors and/or function ports of the projection head are coupled with the function connectors and/or function ports of the head engaging coupling and, when the function connector support is configured in the lowered configuration, the function connectors and/or function ports of the projection head and the function connectors and/or function ports of the head engaging coupling are uncoupled. The interactive game portable unit can further comprise a connector support translation assembly connected to the function connector support and activable to translate the function connector support between the raised configuration and the lowered configuration and wherein the function connector support can comprise a biasing member biasing the function connector support in the lowered configuration. The connector support translation assembly can be operatively connected to the pneumatic actuator.

In an embodiment, the interactive game portable unit further comprises a pressure sensor and a control unit. The pressure sensor monitors air pressure inside an air conduit connecting the pneumatic actuator to the extendable shaft and is in data communication with the control unit to compare the monitored air pressure to at least one air pressure threshold indicative of an obstacle being met while raising or lowering the extendable shaft.

According to a general aspect, there is provided an interactive game portable unit comprising: a base including an extendable shaft translatable between a compacted configuration and an extended configuration, the base comprising a central unit and a plurality of deployable legs mounted to the central unit, the deployable legs being selectively configurable in a compacted configuration and a deployed configuration, wherein, in the compacted configuration of the deployable legs, the base is supported on a floor at least partially by the central unit and, in the deployed configuration of the deployable legs, the base is supported on the floor by the deployable legs with the central unit being spaced-apart from the floor; and a projection head mounted to a distal end of the extendable shaft and translatable therewith, wherein the extendable shaft protrudes outwardly of the central unit in the extended configuration.

In an embodiment, the deployable legs extend adjacent and substantially parallel to the central unit in the compacted configuration.

In an embodiment, the deployable legs are pivotally mounted to an upper portion of the central unit and a lower section of the deployable legs is spaced-apart from the central unit in the deployed configuration.

In an embodiment, the extendable shaft is configurable in the extended configuration solely when the deployable legs are configured in the deployed configuration.

In an embodiment, the deployable legs are configurable in the compacted configuration solely if the extendable shaft is configured in the compacted configuration.

In an embodiment, each one of the deployable legs comprises a material with a low friction coefficient at a lower end thereof.

In an embodiment, the extendable shaft is a telescopic shaft.

In an embodiment, each one of the deployable legs is expandable and compactable in length.

In an embodiment, in the compacted configuration of the deployable legs, the base is supported on a floor solely by the central unit.

In an embodiment, the base comprises three deployable legs equidistantly spaced-apart around the central unit.

In an embodiment, each one of the deployable legs comprises an outer section pivotally mounted to the upper portion of the central unit and an inner section expandable and compactable in length, the inner section having a portion extending below the outer section at least in the deployed configuration.

In an embodiment, in the extended configuration of the extendable shaft, a length of the extendable shaft is longer than a height of the central unit.

According to a general aspect, there is provided an interactive game portable unit comprising: a base including an extendable shaft translatable between a compacted configuration and an extended configuration; a projection head mounted to a distal end of the extendable shaft and translatable therewith; and a sound module comprising a low frequency sub-module located in the base and a high frequency sub-module located in the projection head.

In an embodiment, the interactive game portable unit further comprises a control unit operatively connected to the low frequency sub-module and the high frequency sub-module.

In an embodiment, the low frequency sub-module comprises at least one of an amplifier and a subwoofer.

In an embodiment, the high frequency sub-module comprises at least one of a tweeter and a plurality of high-frequency speakers.

In an embodiment, the interactive game portable unit further comprises at least one audio cable connecting the low frequency sub-module and the high frequency sub-module together.

According to a general aspect, there is provided an interactive game portable unit comprising:
a base including an extendable shaft translatable between a compacted configuration and an extended configuration;
a projection head mounted to a distal end of the extendable shaft and translatable therewith; and
a connector sleeve containing and surrounding a plurality of cables extending between the projection head and the base.

In an embodiment, the connector sleeve extends helically around the extendable shaft and is configurable in a compressed configuration when the extendable shaft is configured in the compacted configuration and a stretched configuration when the extendable shaft is configured the extended configuration.

In an embodiment, the extendable shaft is a telescopic shaft.

In an embodiment, the base comprises a central unit and the extendable shaft protrudes outwardly of the central unit in the extended configuration. The extendable shaft and the connector sleeve can be essentially entirely contained in the central unit in the compacted configuration. In the extended configuration of the extendable shaft, a length of the extendable shaft can be longer than a height of the central unit.

According to a general aspect, there is provided an interactive game portable unit comprising: a base including an extendable shaft and a head engaging coupling, the extendable shaft is translatable between a compacted configuration and an extended configuration wherein the extendable shaft extends outwardly, the head engaging coupling is mounted to a distal end of the extendable shaft and translatable therewith; and a projection head comprising a coupling receiving recess, the head engaging coupling being engageable in the coupling receiving recess to detachably mount the projection head to the distal end of the extendable shaft, wherein each one of the coupling receiving recess and the head engaging coupling comprises an insertion section having a tapered profile.

In an embodiment, each one of the coupling receiving recess and the head engaging coupling further comprises a coupling section wider than the coupling section. The coupling section of the head engaging coupling can further comprise function connectors and/or function ports and the projection head can further comprise function connectors and/or function ports exposed in the coupling section of the coupling receiving recess, the function connectors and/or function ports of the head engaging coupling are complementary to and couplable with the function connectors and/or function ports of the projection head when the head engaging coupling is inserted in the coupling receiving recess of the projection head.

According to a general aspect, there is provided an interactive game portable unit comprising: a base including an extendable shaft and a head engaging coupling, the extendable shaft is translatable between a compacted configuration and an extended configuration wherein the extendable shaft extends outwardly and along a first translation axis, the head engaging coupling is mounted to a distal end of the extendable shaft and translatable therewith; and a projection head comprising a coupling receiving recess with the head engaging coupling being engageable in the coupling receiving recess by translation along a second translation axis, substantially perpendicular to the first translation axis, to detachably mount the projection head to the distal end of the extendable shaft.

In an embodiment, the head engaging coupling further comprises a function connector support having function connectors and/or function ports mounted thereto and the function connector support is selectively configurable in a raised configuration and a lowered configuration and the projection head further comprises function connectors and/or function ports exposed in the coupling receiving recess, the head engaging coupling being engageable in the coupling receiving recess to detachably mount the projection head to the distal end of the extendable shaft, wherein the function connectors and/or function ports of the head engaging coupling are complementary to and couplable with the function connectors and/or function ports of the projection head when the head engaging coupling is inserted in the coupling receiving recess of the projection head and the function connector support is configured in the raised configuration.

In an embodiment, when the function connector support is configured in the lowered configuration, the function connectors and/or function ports of the projection head and the function connectors and/or function ports of the head engaging coupling are uncoupled.

In an embodiment, the interactive game portable unit further comprises a connector support translation assembly connected to the function connector support and activable to translate the function connector support between the raised configuration and the lowered configuration and wherein the function connector support comprises a biasing member biasing the function connector support in the lowered configuration. The interactive game portable unit can further comprise a pneumatic actuator operatively connected to the extendable shaft and to the connector support translation assembly, the pneumatic actuator being activable to configure the extendable shaft between the compacted configuration and the extended configuration and the function connector support between the raised configuration and the lowered configuration.

In an embodiment, the first translation axis is a substantially vertical axis and the second translation axis is a substantially horizontal axis.

According to a general aspect, there is provided a connection assembly between a base and a head, the base comprising an extendable shaft and a head engaging coupling, the extendable shaft is translatable between a compacted configuration and an extended configuration along a first translation axis, the head engaging coupling is mounted to the distal end of the extendable shaft and translatable therewith, and the head comprising a coupling receiving recess with the head engaging coupling being engageable in the coupling receiving recess by translation along a second translation axis, substantially perpendicular to the first translation axis, to detachably mount the head to the distal end of the extendable shaft.

In an embodiment, the head engaging coupling further comprises a function connector support having function connectors and/or function ports mounted thereto and the function connector support is selectively configurable in a raised configuration and a lowered configuration by translation along the first translation axis; and wherein the head further comprises function connectors and/or function ports exposed in the coupling receiving recess, wherein the function connectors and/or function ports of the head engaging coupling are complementary to and couplable with the function connectors and/or function ports of the head when the head engaging coupling is inserted in the coupling receiving recess of the head and the function connector support is configured in the raised configuration. When the function connector support can be configured in the lowered configuration, the function connectors and/or function ports of the head and the function connectors and/or function ports of the head engaging coupling are uncoupled.

In an embodiment, the connection assembly further comprises a connector support translation assembly connected to the function connector support and activable to translate the function connector support between the raised configuration and the lowered configuration and wherein the function connector support comprises a biasing member biasing the function connector support in the lowered configuration. The connection assembly can further comprise a pneumatic actuator operatively connected to the extendable shaft and to the connector support translation assembly, the pneumatic actuator being activable to configure the extendable shaft between the compacted configuration and the extended configuration and the function connector support between the raised configuration and the lowered configuration.

In an embodiment, each one of the coupling receiving recess and the head engaging coupling comprises an insertion section having a tapered profile.

In an embodiment, the first translation axis is a substantially vertical axis and the second translation axis is a substantially horizontal axis.

### BRIEF DESCRIPTION OF THE DRAWINGS

FIG. 1 is a top perspective view of an interactive game portable unit in accordance with an embodiment, in a partially compacted configuration;

FIG. 1a is a top perspective view of the interactive game portable unit of FIG. 1, in a fully compacted configuration;

FIG. 2 is a side elevation view of the interactive game portable unit of FIG. 1, in an extended configuration, projecting on a wall;

FIG. 3 is a top perspective view of the interactive game portable unit of FIG. 1, in the extended configuration;

FIG. 4 is a side elevation view of the interactive game portable unit of FIG. 1, in the partially compacted configuration but wherein deployable legs of a portable base are in a deployed configuration and a housing panel of a central unit has been removed to expose a chamber of a housing of the portable base;

FIG. 5 is a side elevation view, enlarged, of a lower portion of the portable base of the interactive game portable unit of FIG. 1, wherein deployable legs of the portable base are in the deployed configuration;

FIG. 6 is a perspective view, enlarged, of the portable base of the interactive game portable unit of FIG. 1, wherein deployable legs of the portable base are in the deployed configuration and the housing panel of the central unit has been removed to expose the chamber of the housing of the portable base;

FIG. 7 is a bottom perspective view of the portable base of the interactive game portable unit of FIG. 1, in the configuration of FIG. 6, wherein a pneumatic actuator has been removed to expose a portion of a sound module;

FIG. 8 includes FIG. 8a and FIG. 8b, which are respectively a front top perspective view and a rear top perspective view of an extendable shaft of the portable base of the interactive game portable unit of FIG. 1, in an extended configuration and having a head engaging coupling mounted at a distal end thereof;

FIG. 9 is a bottom perspective view of a projection head of the interactive game portable unit of FIG. 1, including at least a portion of a projection module, a lighting module, a sound module, and a motion sensing module;

FIG. 10 is a bottom plan view of the projection head of FIG. 9; and

FIG. 11 is a top perspective view of the projection head of FIG. 9, wherein a top panel and a video projector of the projection module have been removed.

FIG. 12 is a top perspective view of a head engaging coupling at a distal end of the extendable shaft, in accordance with another embodiment, wherein the head engaging coupling includes a function connector support in a lowered configuration;

FIG. 13 is a top perspective view of the head engaging coupling of FIG. 12, wherein the function connector support in a raised configuration;

FIG. 14 is a top perspective view, sectioned, of the head engaging coupling of FIG. 12, wherein the function connector support in the lowered configuration;

FIG. 15 is a top perspective view, sectioned, of the head engaging coupling of FIG. 12, wherein the function connector support in the raised configuration;

FIG. 16 is a top perspective view of a head engaging coupling at the distal end of the extendable shaft, in accordance with another embodiment, wherein the head engaging coupling includes the function connector support in the lowered configuration;

FIG. 17 is a top perspective view of the head engaging coupling of FIG. 16, wherein the function connector support in the raised configuration;

FIG. 18 is a top perspective view, sectioned, of the head engaging coupling of FIG. 16, wherein the function connector support in the lowered configuration;

FIG. 19 is a top perspective view, sectioned, of the head engaging coupling of FIG. 16, wherein the function connector support in the raised configuration; and

FIG. 20 is a top perspective view of the head engaging coupling of FIG. 16, wherein an upper plate of the head engaging coupling is removed and the function connector support in the lowered configuration.

It will be noted that throughout the appended drawings, like features are identified by like reference numerals.

### DETAILED DESCRIPTION

Moreover, although the embodiments of the interactive game portable unit and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the interactive game portable unit, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting. They should correspond to the position and orientation of the interactive game portable unit and corresponding parts when being used to project on a wall, with the “front” corresponding to a position closer to a projector lense of the interactive game portable unit and the “back” corresponding to a position closer to a rear of a projection head of the interactive game portable unit. Positional descriptions should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

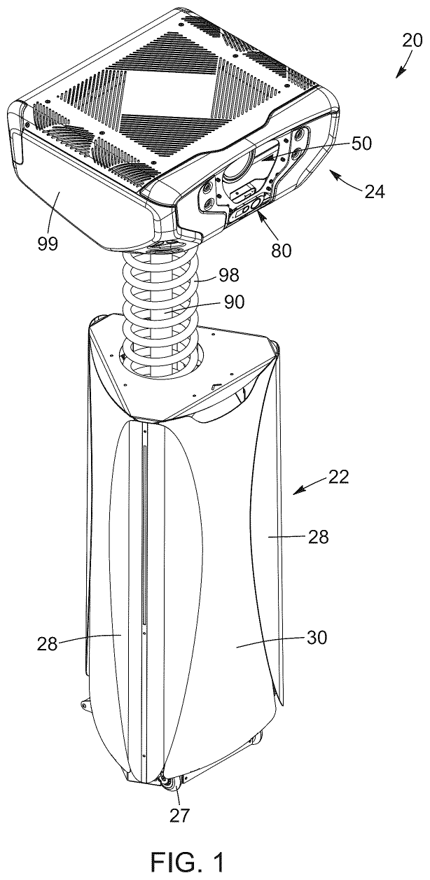

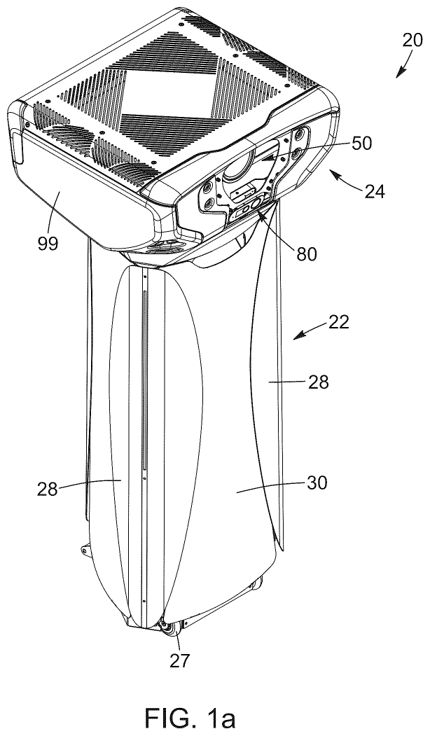

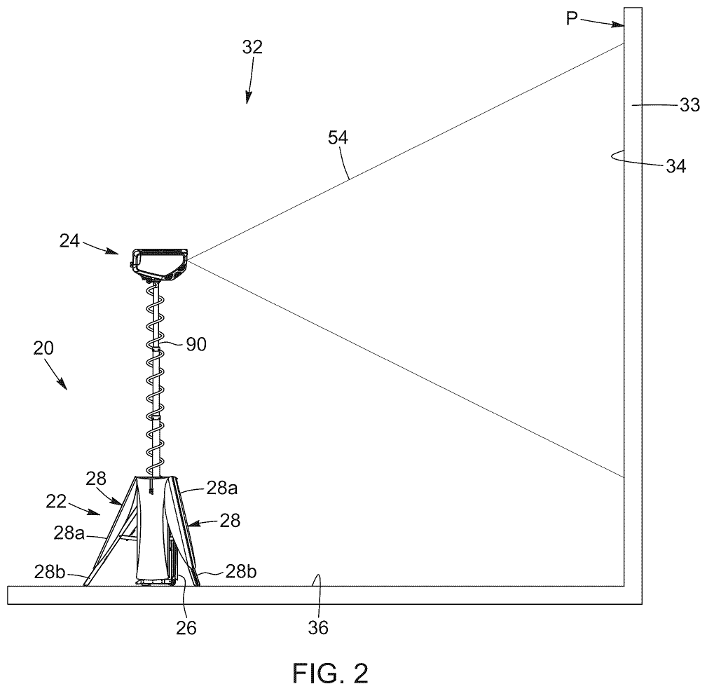

Referring to FIG. 1, there is shown an interactive game portable unit 20 including a portable base 22 and a projection head 24. Hereinafter, the interactive game unit 20 is qualified as portable in that it can be displaceable/movable from one location to another. Instead of being mounted to a ceiling or to a wall to project on an interactive surface, the unit 20 is supported on the ground or on a floor 36 (FIG. 2). In some embodiments, it can be rolled or slidable displaced thereon.

As shown in FIG. 2, the interactive game portable unit 20 is designed and configured to provide an interactive game experience in at least a section of a large room 32, using an interactive surface 34 (or interactive wall section). In an embodiment, the interactive surface 34 extends along a plane P defined by at least a portion of a wall 33 of the room 32 in which the interactive game portable unit 20 is located (or substantially parallel thereto). Thus, the wall 33 used to define the interactive surface 34 can therefore simply be a conventional wall 33 of the room 32 which is being used for the interactive game. For example, and without being limitative, in an embodiment, the interactive game portable unit 20 can be installed in a gymnasium of a school, a sport complex, or the like, to provide an interactive immersive and interactive playground for children positioned in the gymnasium, with at least a section of one wall 33 of the room 32 being used as the interactive surface 34 of the interactive game portable unit 20. One skilled in the art will understand that, in alternative embodiments, the interactive game portable unit 20, can also be installed in any other types of rooms having a sufficient dimension to provide the desired immersive experience such as, for example and without being limitative, a common room, a training room, a hall, etc. In an embodiment, the interactive surface 34 has dimensions ranging between about 12 inches by 7 inches and about 19 feet by 11 feet. In an alternative embodiment, the interactive surface 24 has dimensions ranging between about 8 feet by 4.5 feet and about 19 feet by 11 feet.

One skilled in the art will understand that, in an alternative embodiment, at least a section of the floor 36, the ceiling or any other element (such as a projection screen) located in the room 32 can also be used to define the interactive surface 34. In the course of the present description, the term “wall” will however be used when referring to the structure used to define the interactive surface 34, in order to ease description.

The interactive game portable unit 20 is displaceable in that it can be moved from one location to another and inside one location.

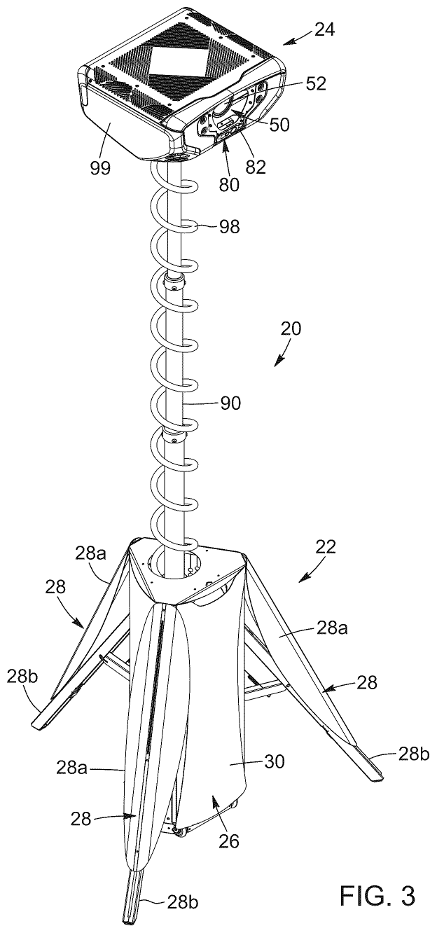

In the non-limitative embodiment shown in FIGS. 1 to 3, the portable base 22 includes a central unit 26 (or central portion) and deployable legs three 28 selectively configurable in a compacted configuration as shown in FIGS. 1 and 1a and a deployed configuration as shown in FIGS. 2 and 3 (for operation, for instance). In the non-limitative embodiment shown in FIGS. 1 to 3, the three deployable legs 28 are equidistantly spaced-apart around the central unit 26. It is appreciated that the number, the shape, and the configuration of the deployable legs 28 can vary from the embodiment shown.

The deployable legs 28 are pivotally mounted to an upper portion of the central unit 26, substantially equidistantly spaced-apart from one another. In addition to being pivotable about the central unit 26, the deployable legs 28 are extendable. More particularly, in the non-limitative embodiment shown, each one of the deployable legs 28 includes an upper section 28a having an upper end pivotally mounted to the upper portion of the central unit 26 and a lower (inner) section 28b mounted to the upper section 28a and translatable thereon to extend or retract a length of the deployable leg 28. The inner/lower section 28b has a portion extending below the upper section 28a at least in the deployed configuration. In the non-limitative embodiment shown, the lower section 28b is also located inwardly with respect to the upper section 28a.

In a non-limitative embodiment, the interactive game mobile unit 20 can include an electric leg actuator (not shown) operatively connected to the deployable legs 28 and activable to selectively configure the deployable legs 28 in the compacted and the deployed configurations. In an embodiment, the leg actuator configures simultaneously all the legs in one of the compacted and the deployed configurations.

The projection head 24 is mounted to the central unit 26 and can be selectively configured in a partially compacted configuration as shown in FIG. 1, wherein the projection head 24 is located adjacent to (or closer to) the central unit 26, in a fully compacted configuration as shown in FIG. 1a, wherein the projection head 24 is juxtaposed to the central unit, and a raised (or extended) configuration as shown in FIGS. 2 and 3, wherein the projection head 24 is vertically spaced-apart from the central unit 26 (for operation, for instance).

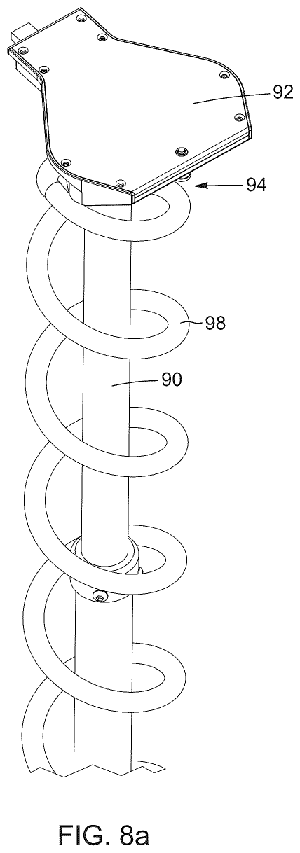

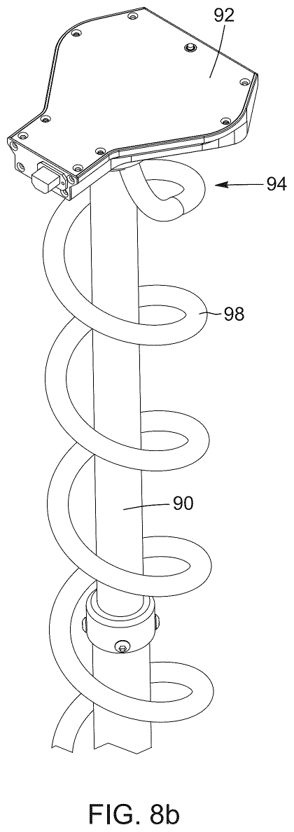

More particularly, the portable base 22 includes an extendable shaft 90 mounted to the central unit 26 and protruding outwardly therefrom, at least in an at least partially raised configuration thereof (e.g. FIG. 1). In the embodiment shown, the extendable shaft 90 is a telescopic shaft. As shown in FIG. 8, the portable base 22 also includes a head engaging coupling 92 at a distal end 94 thereof. The head engaging coupling 92 is designed and configured to quickly operatively connect and disconnect the projection head 24 to the portable base 22, as will be described in more details below.

In an embodiment, in the extended configuration of the extendable shaft, a length of the extendable shaft 90 can be longer than a height of the central unit 26.

In a fully compacted configuration (FIG. 1a), the projector head 24 is located adjacent to the base 22 and the extendable shaft 90 substantially entirely contained inside the base 22. The interactive game portable unit 20 can be configured in the fully compacted configuration of the projector head 24 for storage and displacement purposes, for instance.

The extendable shaft 90 is configurable between the fully compacted configuration and an extended configuration, with a plurality of configurations located inbetween, such as the one shown in FIG. 1.

Referring back to FIGS. 1 to 3, in an embodiment, to ensure stability to the interactive game portable unit 20, the extendable shaft 90 of the portable base 22 can be configured in the raised configuration solely when the deployable legs 28 are configured in the deployed configuration. In addition, the deployable legs 28 cannot be configured in the compacted configuration if the extendable shaft 90 is configured in the raised configuration.

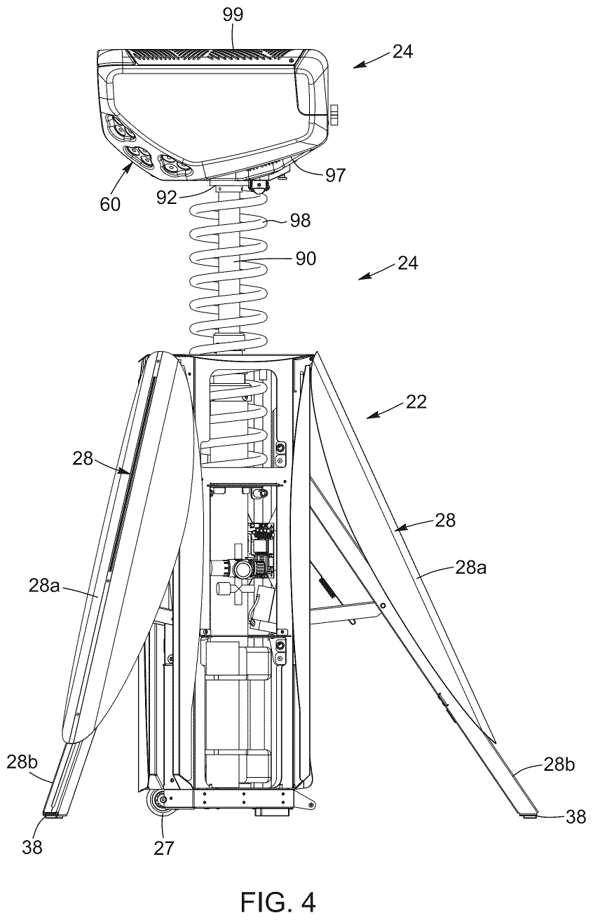

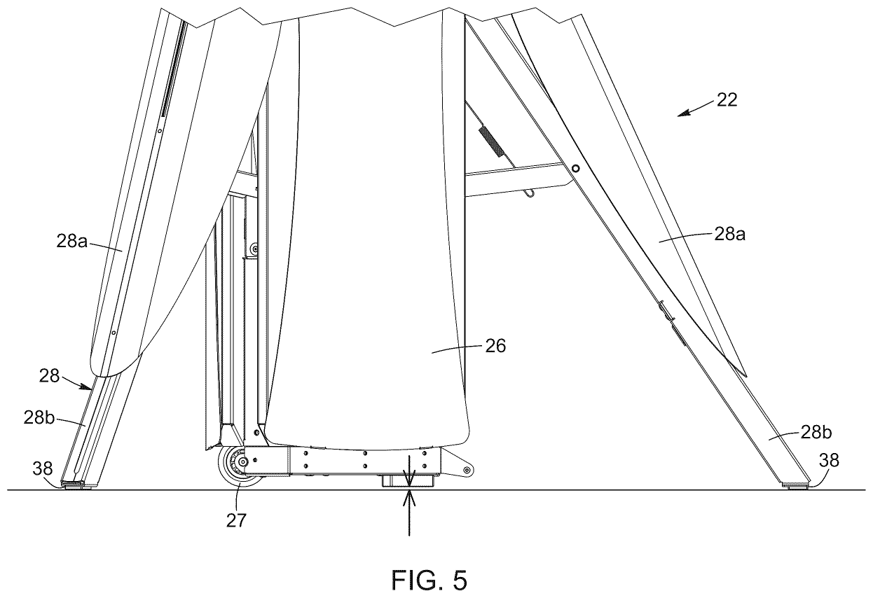

Referring now to FIGS. 4 and 5, in an embodiment, when the deployable legs 28 are configured in the deployed configuration, the portable base 22 rests solely on lower ends of the deployable legs 28, i.e. the central unit 26 of the portable base 22 is spaced-apart from the floor/ground 36.

In the embodiment, lower ends of the deployable legs 28 includes Teflon® pads 38 (or Fluorosint®), i.e. a polytetrafluoroethylene (PTFE) with a dynamic coefficient of friction of about 0.10, or any other suitable material characterized by a low friction coefficient, which allows the interactive game portable unit 20 to slide on the floor/ground 36, instead of tilting, in case of impact when the legs 28 are configured in the deployed configuration. For instance, other non-limitative materials that can be used to coat or cover lower ends of the deployable legs 28 includes nylon with additives such as Nyloil® (dynamic coefficient of friction of about 0.12), UHMW such as Tivar® 88 (dynamic coefficient of friction of about 0.14) and Tivar® HPV (dynamic coefficient of friction of about 0.09), and PET-P such as Ertalyte® (dynamic coefficient of friction of about 0.19). In an embodiment, the dynamic coefficient of friction is below 0.3 and, in a particular embodiment, below, 0.2.

In turn, the central unit 26 includes rollers 27 mounted to a lower portion thereof and supporting same on the floor/ground 36. Therefore, at least in the compacted configuration of the deployable legs 28, the interactive game portable unit 20 can be displaceable from one location to another or inside one location by rolling the portable unit 20 on the rollers 27. It is appreciated that, in an alternative embodiment, the rollers 27 can be replaced by sliding pads, skids, casters, furniture sliders, and the like.

When the deployable legs 28 are configured in the compacted configuration, the central unit 26 of the portable base 22 contacts the floor/ground 36 and can be displaceable thereon. In the compacted configuration of the deployable legs 28, the deployable legs 28 can contact the floor/ground 36 and be displaceable thereon or can be spaced-apart from the floor/ground 36 and the interactive game portable unit 20 can be supported solely by the central unit 26.

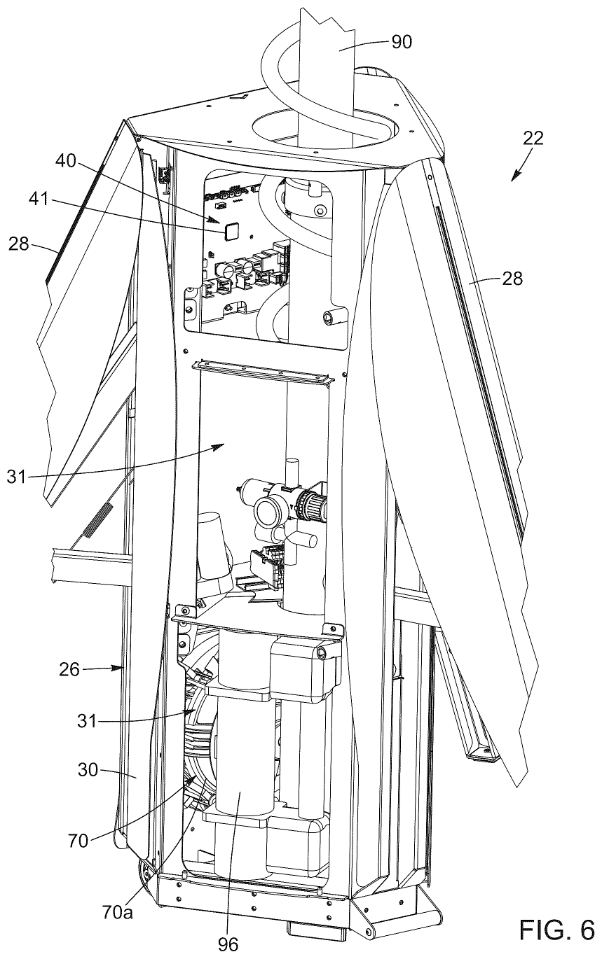

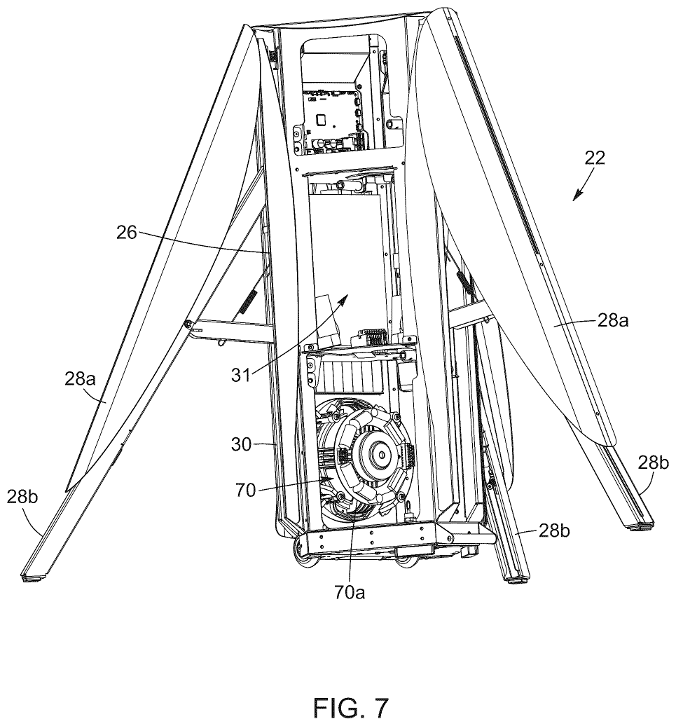

Turning now to FIG. 6, the central unit 26 includes a housing 30 delimiting a chamber 31. In the embodiment of FIG. 6, a housing panel has been removed to expose at least some of the unit components contained in the chamber 31. In the non-limitative embodiment shown, the chamber 31 is divided into three levels, as will be described in more details below.

In the embodiment shown, the interactive game portable unit 20 further includes a pneumatic actuator 96 (such as an air compressor), contained in a first and lower level of the chamber 31 of the central unit 26 and operatively connected to the extendable shaft 90. The pneumatic actuator 96 is actuated to raise and lower the extendable shaft 90 (i.e. extend and compact the extendable telescopic shaft 90). By its design, the pneumatic actuator 96 is a substantially safe actuator allowing a relatively slow compaction of the extendable shaft 90 in case of malfunction. If the pneumatic actuator 96 or associated components fail, air will leak slowly, preventing a quick projection head 24 drop.

The interactive game portable unit 20 can further include a pressure sensor (not shown) monitoring the air pressure inside the air conduit in fluid communication with the pneumatic actuator 96. The pressure sensor can be in data communication with a control unit 40, which will be described in more details below, which compares the measured pressure to at least one air pressure set-point or threshold. For instance, if the air pressure measured by the pressure sensor is above a predetermined threshold, the control unit 40 can associate the event to an obstacle being met while raising or lowering the extendable shaft 90 and stop the lifting/lowering operation.

It is appreciated that the interactive game portable unit 20 can include other sensors such as and without being limitative a gyroscope or an accelerometer which can be operatively connected to the control unit 40 and which data can be associated to an obstacle being met while raising or lowering the extendable shaft 90 or object hitting the interactive game portable unit 20.

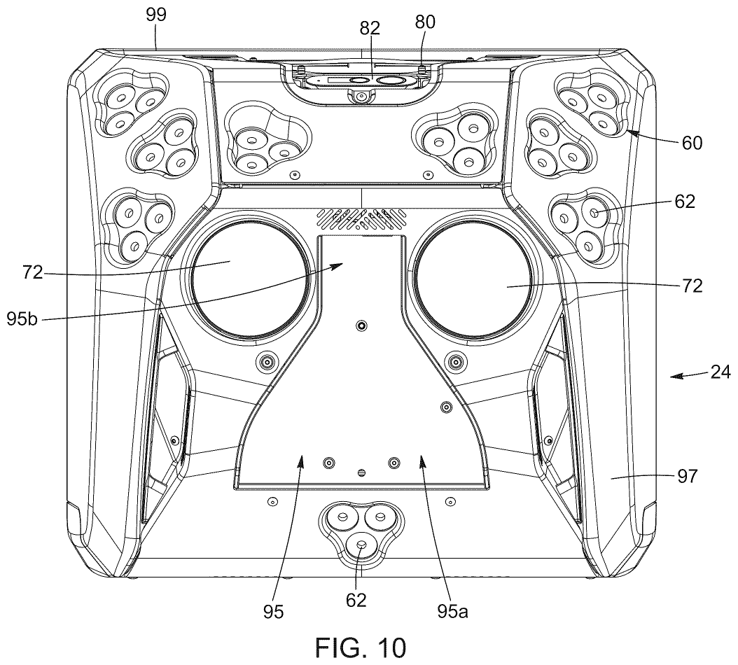

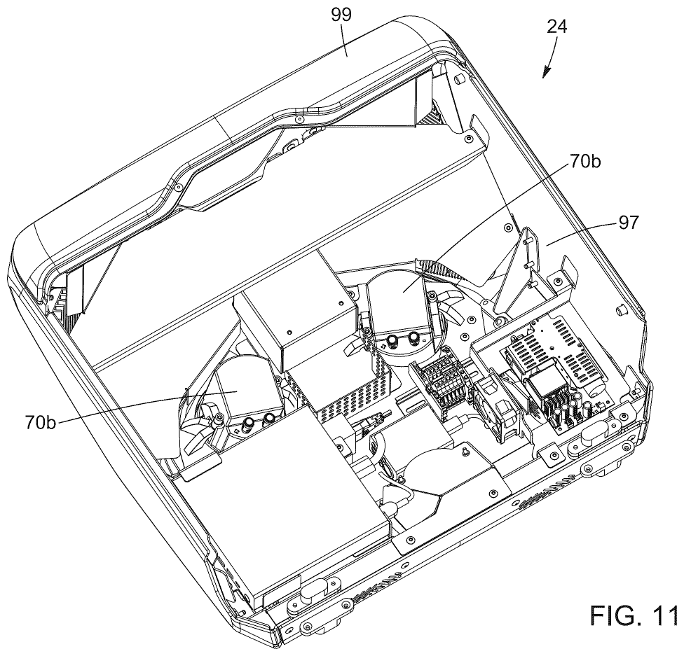

Amongst others and in addition, the chamber 31 houses a portion of a sound module 70, also located in the first and lower level of the chamber 31. More particularly, a low frequency sub-module 70a of the sound module 70 is contained inside the chamber 31, while a high frequency sub-module 70b of the sound module 70 (FIG. 11), including a tweeter and/or a plurality of high-frequency speakers 72 (FIG. 10), is contained inside the projection head 24. The low frequency sub-module 70a, including the amplifier and the subwoofer, if any, being heavier, it reduces a weight of the projection head 24, which is raised and lowered, when contained in the central unit 26. Furthermore, by having the relatively heavy components located in the base 22 and, more particularly, the central unit 26, a center of gravity of the interactive game portable unit 20 is low, providing substantial stability and safety to the interactive game portable unit 20. Furthermore, mounting the projection head 24 to the distal end 94 of the extendable shaft 90 is easier if the projection head 24 is lighter.

The chamber 31 also contains the pneumatic actuator valves, air controls, and leg actuators, which can be electric leg actuators. In the non-limitative embodiment shown, they are located in a second and middle level of the chamber 31.

In a third and upper level, the chamber 31 contains electronic components, user buttons/interfaces, and a computer 41 (FIG. 6).

It is appreciated that the location of the various components, including the pneumatic actuator 96, the low frequency sub-module 70a, the pneumatic actuator valves, the air controls, the audio amplifier, the leg actuators, the electronic components, the user buttons/interfaces, and the computer, inside the chamber 31 can vary from the embodiment shown.

In the embodiment shown, the interactive game portable unit 20 includes the control unit 40 (or controller), a projection module 50 (or projection source(s)), a lighting module 60 (or light source(s)), the sound module 70 (or acoustic source(s)) and a motion sensing module 80 (or motion sensor(s)). In an alternative embodiment, the interactive game portable unit 20 can however be free of sound module 70.

The projection module 50, the lighting module 60, and the motion sensing module 80 are located in/mounted to the projection head 24, to ensure that they do not impede on the action of the users moving in the room 32 and can respectively project adequately on the interactive surface 34, direct the light mostly on the floor and limit light emission directed towards the interactive surface 34, and have a substantially unobstructed field of view on the interactive surface 34. One skilled in the art will however understand that, in an alternative embodiment, at least one a portion of the projection module 50, the lighting module 60, and the motion sensing module 80 can be partially located in the central unit 26 of the portable base 22.

The control unit 40 can be located in the projection head 24 or the central unit 26, or a portion thereof can be provided in both.

It is also appreciated that the projection module 50, the lighting module 60, and the motion sensing module 80 are operatively connected to one another via the control unit 40. More particularly, the projection module 50, the lighting module 60, the sound module 70, and the motion sensing module 80 are connected to the control unit 40 (i.e. are in data communication with the control unit 40) to allow the control unit 40 to manage the operation thereof and provide the desired interactive and immersive game experience to the users in the room 32 through the inputs provided by the motion sensing module 80 and the outputs provided by the projection module 50, the lighting module 60 and/or the sound module 70.

One skilled in the art will understand that the data connection between the control unit 40 and each one of the projection module 50, lighting module 60, sound module 70 and motion sensing module 80 can be any type of connection which allows data transfer therebetween. For example, and without being limitative, in an embodiment, the connection between the control unit 40 and the projection module 50, lighting module 60, sound module 70 and/or motion sensing module 80 is a wired connection. One skilled in the art will however understand that, in an alternative embodiment, the connection between the control unit 40 and the projection module 50, lighting module 60, sound module 70 and/or motion sensing module 80 can be a wireless connection, with the control unit 40 and the corresponding one of the projection module 50, lighting module 60, sound module 70 and/or motion sensing module 80 being provided with communication hardware (e.g. receiver/transceiver) to allow wireless connection therebetween.

In the embodiment shown, the data connection between the control unit 40 and each one of the projection modules 50, the lighting module 60, sound module 70 and motion sensing module 80 is at least partially a wired connection wherein wires extend between the unit/modules located in the projection head 24 and the central unit 26. In the embodiment shown, all the wires extending between the projection head 24 and the central unit 26 are contained inside a connector sleeve 98 extending between the projection head 24 and the central unit 26, extending helically around the extendable shaft 90. Therefore, the connector sleeve 98 can be configured in at least partially compressed configuration (FIG. 1) when the extendable shaft 90 is configured a partially compacted configuration or the fully compacted configuration (FIG. 1a). The connector sleeve 98 is configured in a stretched configuration (FIGS. 2 and 3) when the extendable shaft 90 is configured the extended configuration.

The connector sleeve 98 contains and surrounds a plurality of cables (electric cables, audio cables, data transfer cables, sound transfer cables, etc) extending between the projection head 24 and the portable base 22 and, more particularly, the central unit 26 thereof. In a fully compacted configuration (FIG. 1a), the connector sleeve 98 is entirely contained in the third and upper level of the chamber 31.

In an embodiment, the data communication cables between the projection head 24 and the portable base 22 are contained in the connector sleeve 98. In addition, the audio cables connecting the computer (or control unit) located in the projection head 24, the low frequency sound sub-module 70a located in the projection head 24, and the high frequency sound sub-module 70b located in the central unit 26 of the portable base 22 are also contained in the connector sleeve 98. Furthermore, the connector sleeve 98 can contain 110-volt and 240-volt cables.

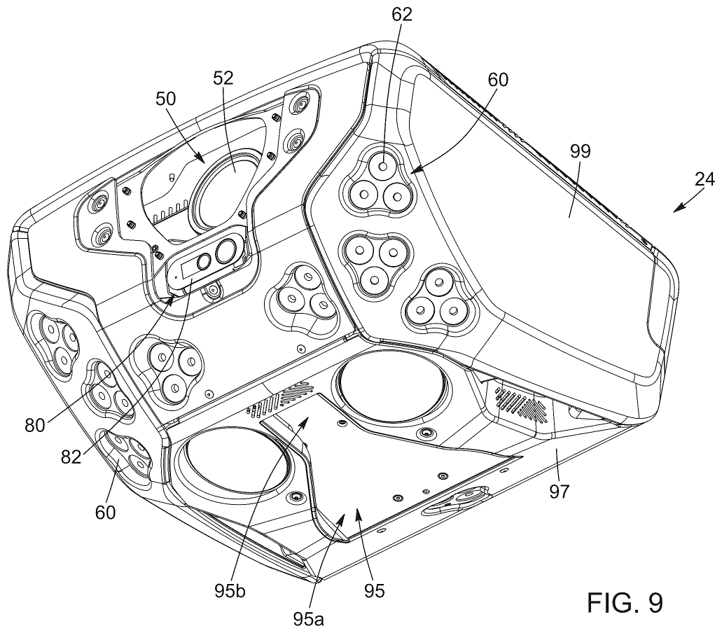

In the embodiment shown, the projection head 24 is removable detachable to the distal end 94 of the extendable shaft 90. As mentioned above, the head engaging coupling 92 is mounted to the distal end 94. A coupling receiving recess 95 is defined in a lower face 97 of a casing 99 of the projection head 24 (see FIGS. 9 and 10). In the non-limitative embodiment shown, the coupling receiving recess 95 can be divided into two sections: an insertion section 95a and a coupling section 95b. The insertion section 95a is trapezoidal in shape with a tapered profile to ease the alignment during insertion of the head engaging coupling 92. In the non-limitative embodiment shown, the coupling section 95b is substantially rectangular in shape, being the support for the connectors and their connections, making sure that they are inserted straight once aligned.

Thus, the extendable shaft 90 is configurable in the extended configuration and the compacted configuration by translation along a first translation axis, which is a vertical axis in the embodiment shown. The head 24 is engageable with the head engaging coupling recess 95 by translation along a second translation axis, perpendicular to the first translation axis, which is a horizontal axis in the embodiment shown.

It is appreciated that the connection assembly can be used to mount head, such as the projection head 24, to any base and not necessarily the base of an interactive game portable unit 20, as described above and shown in the figures. More particularly, the connection assembly can used between any base, including an extendable shaft, and a head to detachably the head thereto. In such connection assembly, the extendable shaft is translatable between a compacted configuration and an extended configuration along a first translation axis and includes a head engaging coupling mounted to the distal end thereof and translatable therewith. The head includes a coupling receiving recess with the head engaging coupling being engageable in the coupling receiving recess by translation along a second translation axis, perpendicular to the first translation axis, to detachably mount the head to the distal end of the extendable shaft. In the embodiment, wherein the first translation is a vertical axis, the second translation axis is the horizontal axis.

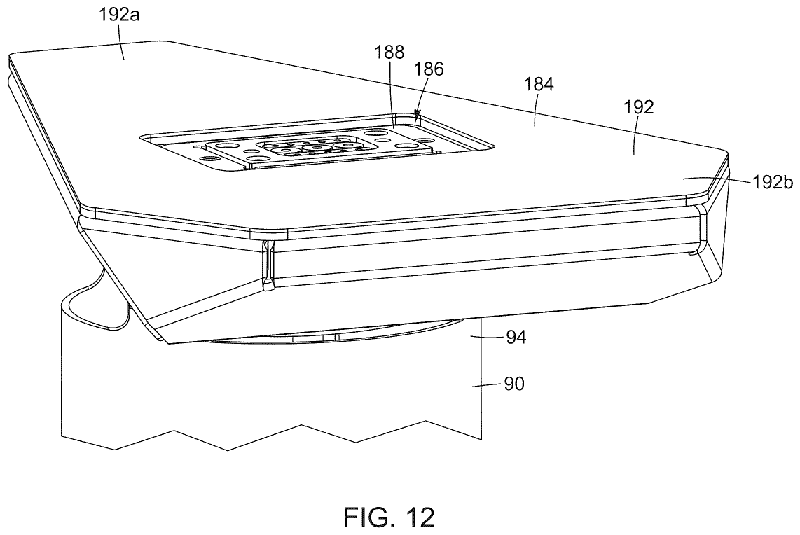

Still referring to FIGS. 12 to 15, the head engaging coupling 92 includes electric (power) and data connector/ports (or function connectors and/or ports) to allow data and power communication between the portable base 22 and the projection head 24. The projection head 24 includes complementary function connectors/ports engageable therewith. The complementary function connectors/ports are located in or in proximity of the coupling receiving recess 95. Therefore, upon engagement of the head engaging coupling 92 inside the coupling receiving recess 95, the complementary function connectors/ports are operatively connected together. Furthermore, the projection head 24 is safely locked to the distal end 94 of the extendable shaft 90.

Turning now to FIGS. 12 to 14, there is shown an alternative embodiment of the head engaging coupling 92, wherein the features are numbered with reference numerals in the 100 series which correspond to the reference numerals of the previous embodiment. As the head engaging coupling 92, the head engaging coupling 192 is mounted to the distal end 94 of the extendable shaft 90. In addition, the external shape of the head engaging coupling 192 is similar to the external shape of the head engaging coupling 92 to be removably insertable in the coupling receiving recess 95. More particularly, the head engaging coupling 92 can be divided into two sections: an insertion section 192a and a coupling section 192b. The insertion section 192a is trapezoidal in shape with a tapered profile to ease the alignment during coupling. The coupling section 192b is wider, being the support for the function connectors/ports.

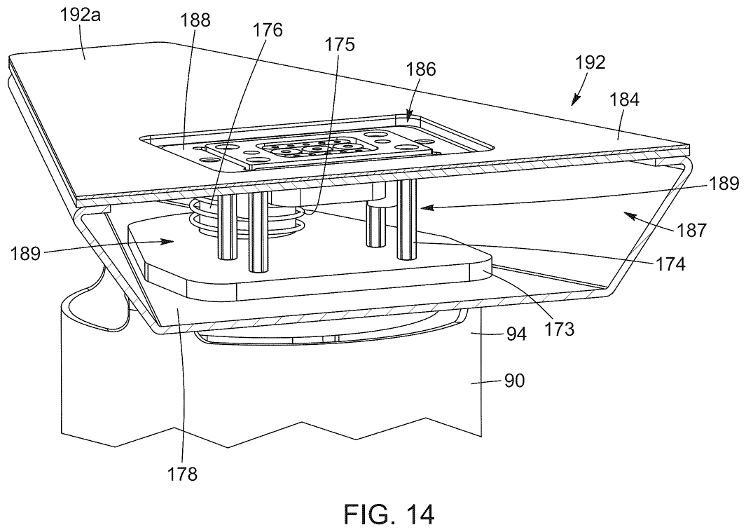

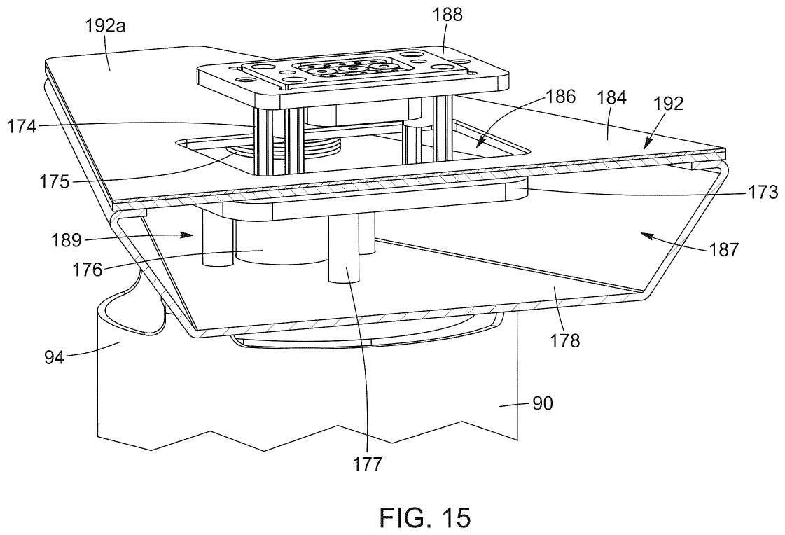

In the embodiment of FIGS. 12 to 15, the head engaging coupling 192 includes an upper plate 184 with an opening 186 defined therein. As shown in FIGS. 14 and 15, the head engaging coupling 192 has a chamber 187 defined therein, partially delimited by the upper plate 184.

The head engaging coupling 192 further includes a function connector support 188 having a plurality of function connectors and/or function ports exposed outwardly thereon. The function connectors and/or ports can be data transfer connectors or ports, audio connectors or ports or electric connectors or ports, for instance. The function connector support 188 can include solely function ports, solely function connectors or a combination of function ports and function connectors. The function connectors and/or function ports are complementary to the function connectors and/or function ports provided and exposed in the coupling receiving recess 95 of the projection head 24 and engageable therewith.

The function connectors and/or function ports of the function connector support 188 are operatively connected to the cables contained and surrounded by the connector sleeve 98 (not shown in FIGS. 12 to 15).

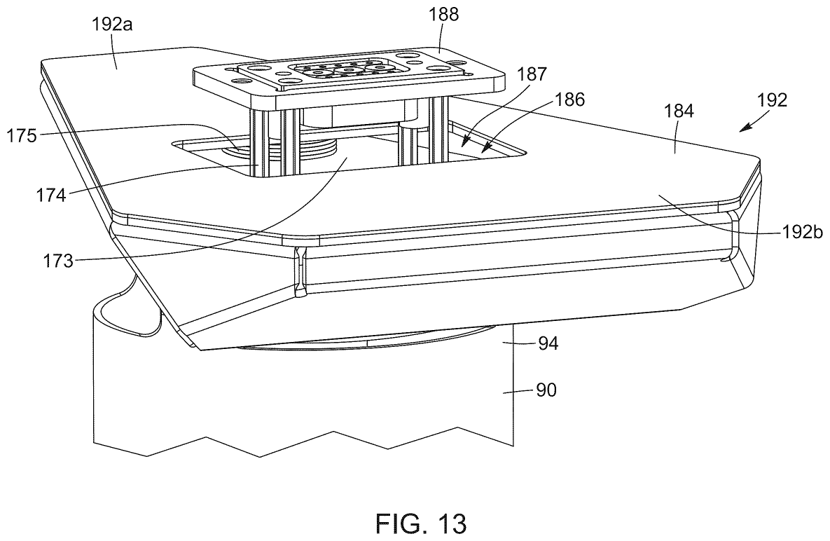

The head engaging coupling 192 further includes a connector support translation assembly 189 (FIGS. 14 and 15) contained in the chamber 187 and operatively connected to the function connector support 188 to translate same between a lowered configuration (FIGS. 12 and 14) and a raised configuration (FIGS. 13 and 15).

As mentioned above, the external shape of the head engaging coupling 192 is substantially complementary in shape with the shape of the coupling receiving recess 95 defined in the lower face 97 of the casing 99 of the projection head 24. When the head engaging coupling 192 is inserted in the coupling receiving recess 95, the function connector support 188 can be translated from the lowered configuration to the raised configuration to couple the function connectors and/or function ports of the function connector support 188 with the function connectors and/or function ports provided in the coupling receiving recess 95 of the projection head 24. When the function connectors and/or function ports of the function connector support 188 and the projection head 24 are coupled together, at least power is provided to the projection head 24 and data transfer is possible.

Referring now to FIGS. 14 and 15, a non-limitative embodiment of the connector support translation assembly 189 will be described. The connector support translation assembly 189 includes a base plate 173 and a plurality of spacing posts 174 protruding therefrom. In the non-limitative embodiment shown, the connector support translation assembly 189 includes four spacing posts 174 but it is appreciated that the number and their configuration can vary. The function connector support 188 is mounted to upper ends of the spacing posts 174, opposed to the ends secured to the base plate 173. The spacing posts maintain the function connector support 188 vertically spaced-apart from the base plate 173.

The connector support translation assembly 189 further includes a biasing member 175, which is embodied by a coiled spring in FIGS. 14 and 15, to maintain the function connector support 188 in the lowered configuration, i.e. when the function connectors and/or function ports of the function connector support 188 and the projection head 24 are uncoupled. The connector support translation assembly 189 also includes a biasing member supporting post 176 onto which the biasing member 175 is coiled.

As shown in FIG. 15, the connector support translation assembly 189 further includes translation posts 177. In the non-limitative embodiment shown, the connector support translation assembly 189 includes three translation posts 177 but it is appreciated that the number and their configuration can vary. The translation posts 177 translate inside and outside the chamber 187 into openings defined in a lower plate 178 of the head engaging coupling 192. The base plate 173 is mounted to an upper end of the translation posts 177 and therefore, translates simultaneously therewith. In the raised configuration, they are extended in the chamber and the base plate 183 is located close to the opening 186. Therefore, the function connector support 188 protrudes outwardly and is located above and spaced-apart from the upper plate 184 of the head engaging coupling 192.

In the lowered configuration, the translation posts 177 are mostly contained in the extendable shaft 90 and the base plate 183 abuts against (or is juxtaposed or adjacent to) the lower plate 178 of the head engaging coupling 192. In the lowered configuration, the function connector support 188 is substantially aligned with the upper plate 184 of the head engaging coupling 192 and substantially closes the opening 186 defined therein.

As mentioned above, the biasing member 175 biases the function connector support 188 in the lowered configuration. In the raised configuration, the biasing member 175 is in a stressed state, i.e. compressed, as shown in FIG. 14.

The connector support translation assembly 189 also includes an actuator (not shown) to translate the translation posts 177 with respect to the head engaging coupling 192 and into the openings defined in the lower plate 178 of the head engaging coupling 192. In a non-limitative embodiment, the translation posts 177 are engaged in translation by the pneumatic actuator 96.

Thus, when the extendable shaft 90 is configured in the compacted configuration, the head engaging coupling 192 located at the distal end 94 of the extendable shaft 90 can be coupled with (i.e. inserted) in the coupling receiving recess 95 of the projection head 24. Once the head engaging coupling 192 and the projection head 24 are coupled together, the function connector support 188 can be translated by actuating the connector support translation assembly 189 from the lowered configuration to the raised configuration to couple the function connectors and/or function ports of the function connector support 188 with the function connectors and/or function ports provided in the coupling receiving recess 95 of the projection head 24. The translation of the function connector support 188 from the lowered configuration to the raised configuration and vice-versa can be carried out when the extendable shaft 90 is configured in the compacted configuration or the raised configuration.

In an embodiment, the function connector support 188 is configured in the lowered configuration when the extendable shaft 90 is configured in the compacted configuration. As the extendable shaft 90 begins its extension, the function connector support 188 is simultaneously configured in the raised configuration to engage its function connectors and/or function ports with the ones provided in the coupling receiving recess 95. Therefore, the extendable shaft 90 and the connector support translation assembly 189 can be operatively connected to the same pneumatic actuator 96.

Thus, as pneumatic pressure is generated to extend the extendable shaft 90, the same compressed gas is used to raise the function connector support 188 in the raised configuration. Thus, the function connectors and/or function ports of the function connector support 188 are engaged with the function connectors and/or function ports of the projection head 24 at the beginning of the lifting operation of the extendable shaft 90.

When the extendable shaft 90 is compacted, the function connectors and/or function ports of the function connector support 188, engaged with the function connectors and/or function ports of the projection head 24, are disengaged once the extendable shaft 90 is substantially/essentially in the compacted configuration. The biasing member 175 ensures that the function connector support 188 returns to the lowered configuration when the gas pressure lowers.

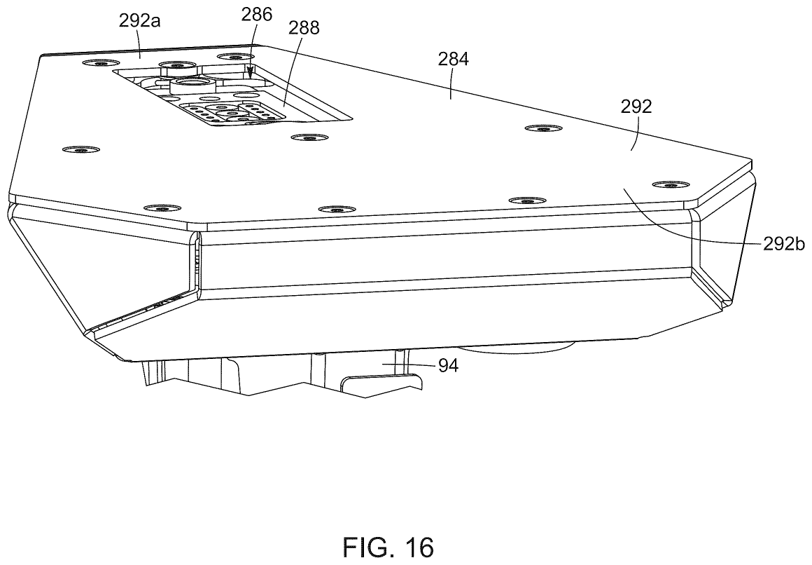

Turning now to FIGS. 16 to 20; there is shown an alternative embodiment of the head engaging coupling 92, 192 wherein the features are numbered with reference numerals in the 200 series which correspond to the reference numerals of the previous embodiment.

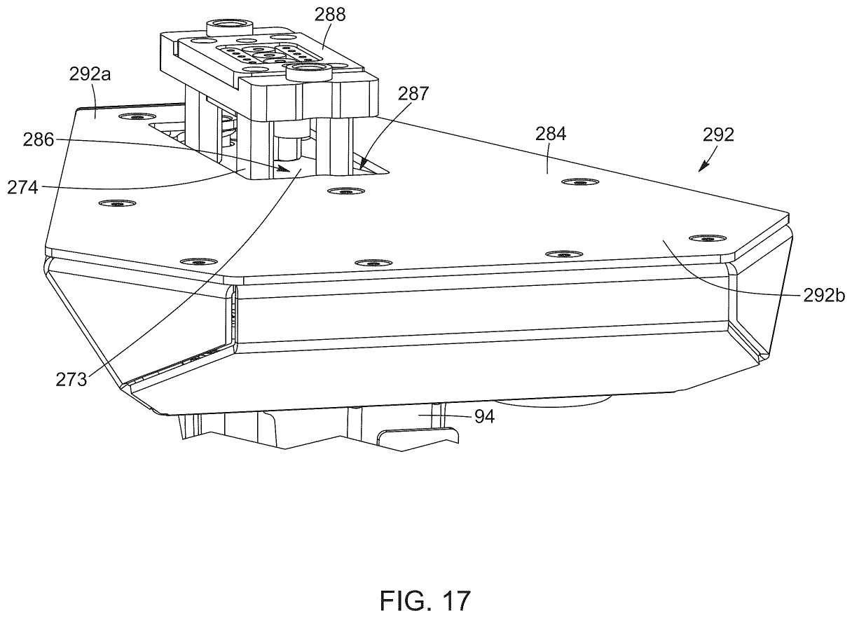

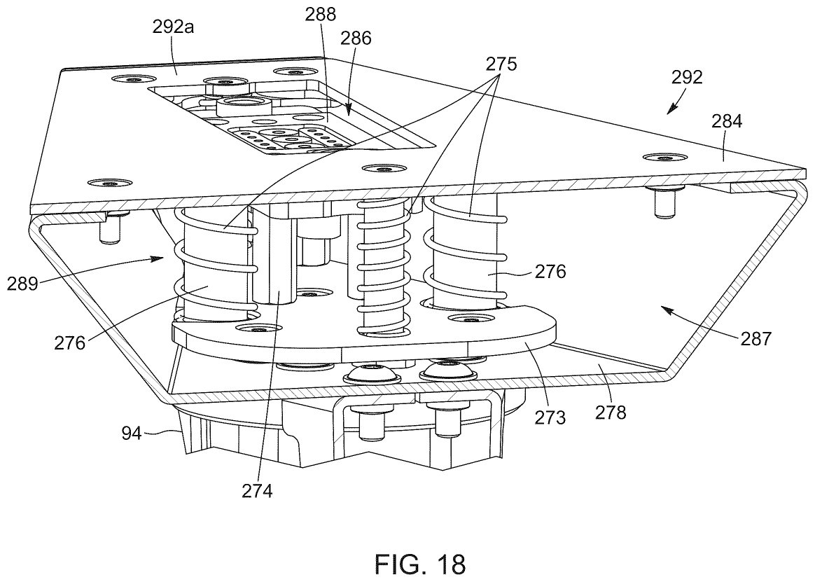

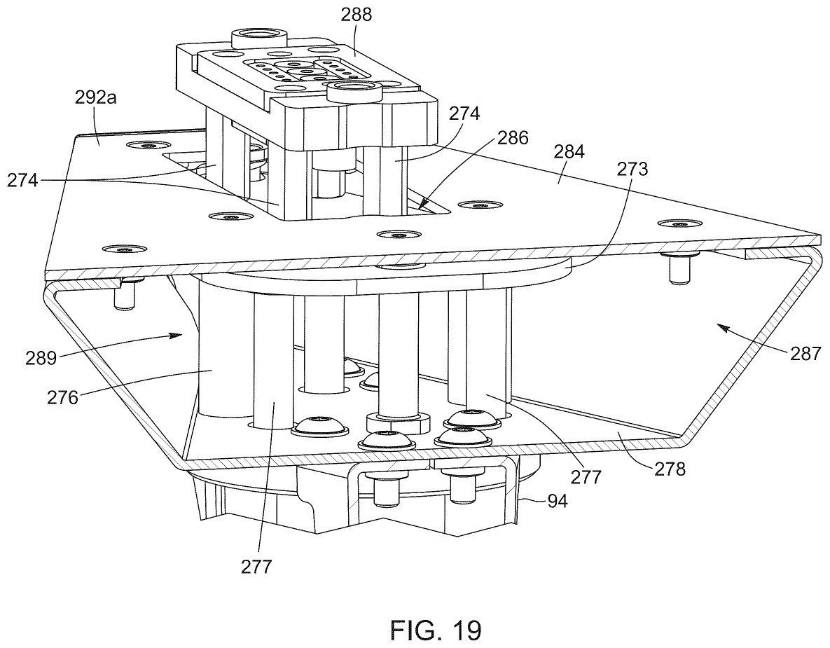

The head engaging coupling 292 shares several similarities es with the head engaging coupling 192, the difference being located mainly in the connector port translation assembly 289 (FIGS. 18 to 20) contained in the chamber 287 and operatively connected to the function connector support 288 to translate same between the lowered configuration (FIGS. 16, 18, and 20) and the raised configuration (FIGS. 17 and 19).

As the connector support translation assembly 189, the connector support translation assembly 289 includes a base plate 273 and four spacing posts 274 protruding therefrom. Once again, it is appreciated that the number and the configuration of the spacing posts 274 as well as the shape and the configuration of the base plate 273 can vary. The function connector support 288 is mounted to upper ends of the spacing posts 274, opposed to the ends secured to the base plate 273. The spacing posts 274 maintain the function connector support 288 vertically spaced-apart from the base plate 273.

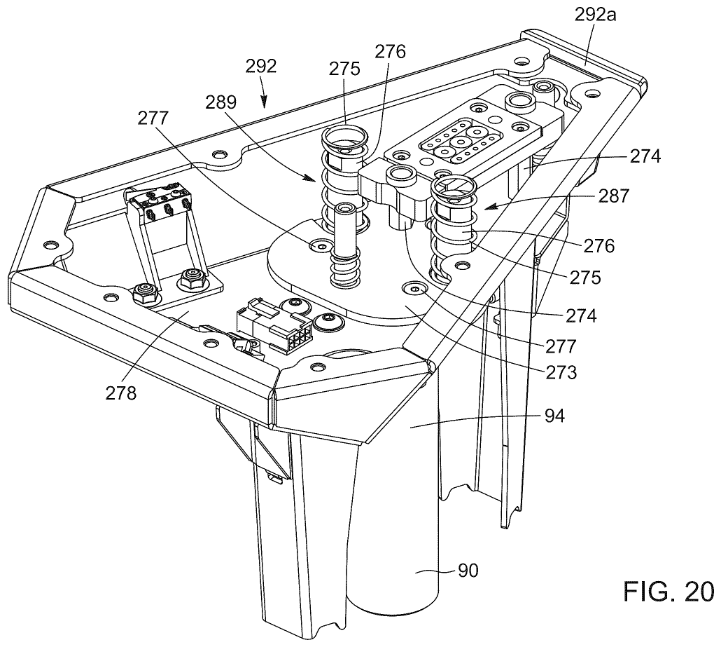

The connector support translation assembly 289 further includes three biasing members 275, which are embodied by a coiled spring in FIGS. 18 and 20, to bias and maintain the function connector support 288 in the lowered configuration, i.e. when the function connectors and/or function ports of the function connector support 288 and the projection head 24 are uncoupled. The connector support translation assembly 289 also includes three biasing member supporting post 276 (one for each one of the three biasing members 275) onto which a respective one of the biasing members 275 is coiled.

As shown in FIG. 19, the connector support translation assembly 189 further includes three translation posts 277. Once again, it is appreciated that the number and the configuration of the translation posts 277 can vary. The translation posts 277 translate inside and outside the chamber 287 into openings defined in the lower plate 278 of the head engaging coupling 292. The base plate 273 is mounted to an upper end of the translation posts 277 and therefore, translates simultaneously therewith. In the raised configuration, they extend in the chamber 287 and the base plate 283 is located close to the opening 186. Therefore, the function connector support 288 protrudes outwardly and is located above and spaced-apart from an upper surface of the upper plate 284 of the head engaging coupling 292.

In the lowered configuration, the translation posts 277 are mostly contained in the extendable shaft 90 and the base plate 283 abuts against (or is juxtaposed or adjacent to) the lower plate 278 of the head engaging coupling 292. In the lowered configuration, the function connector support 283 is slightly recessed with respect to an upper surface of the upper plate 284 of the head engaging coupling 292 (FIGS. 16 and 18) and substantially closes the opening 286 defined therein.

As mentioned above, the biasing members 275 bias the function connector support 288 in the lowered configuration. In the raised configuration, the biasing members 275 are in a stressed state, i.e. compressed.

The connector support translation assembly 289 also includes an actuator (not shown) to translate the translation posts 277 with respect to the head engaging coupling 292 and into the openings defined in the lower plate 278 of the head engaging coupling 292, which can be the pneumatic actuator 96.

The engagement/disengagement method between the head engaging coupling 292 with the projection head 24 being similar to the embodiment described in reference to FIGS. 12 to 15, it will not be described in further details.

In an embodiment, the control unit 40 includes one or more computing device 41 (FIG. 6) in data communication with the projection module 50, lighting module 60, sound module 70 and/or motion sensing module 80. The computing device(s) can include a memory for storing instructions, data and the like and at least one processor for processing data. One skilled in the art will understand that, in an alternative embodiment (not shown), the control unit 40 can include a combination of a central computing device, connected to remote computing device(s), such as server(s) or the like and communicating with one another over a network, such as, for example and without being limitative, a local area network (LAN), a wide area network (WAN), such as the Internet, or the like. In another alternative embodiment, the control unit 40 can be a remote computing device, communicating with the projection module 50, lighting module 60, sound module 70 and/or motion sensing module 80 over a network, such as, for example and without being limitative, a local area network (LAN), a wide area network (WAN), such as the Internet, a wireless private area network (WPAN) or the like.

In the embodiment shown in the figures, the motion sensing module 80 includes a motion sensor 82 (FIG. 3) having a motion sensor field of view configured to intersect with the interactive surface 34. The sensing module 80 also has a field of view that intersects with a portion of the room and its floor in which the interactive game portable unit 20 is located, being able to detect real-world elements, such as objects and people, in its environment.

The at least one motion sensor 82 is configured to sense motion of real-world elements within the motion sensor field of view in order to detect the occurrence and the position of a contact between each one of the real world elements and the interactive surface 34 (i.e. detect when a real world element intersects with the plane P defining the interactive surface 34 and detect the position of the real world element within the interactive surface 34, when such contact occurs) or detect the occurrence and the position of real world element(s) within the field of view of the at least one motion sensor 82. In view of the above, in an embodiment, the data from the motion sensing module 80 can be used to generate interaction data representative of the contact between the real-word elements and the plane P defining the interactive surface 34 and/or the occurrence of an event within the field of view of the motion sensing module 80. For example, and without being limitative, the interaction data can include data relative to the occurrence of a contact, the position (i.e. the coordinates) of the contact of the real-world element on the interactive surface, the occurrence of an event within the field of view of the motion sensing module 80, etc.

In the course of the present document, the term “real-word element” is understood to refer to any real-world object (e.g. ball), person (or a body part thereof), or the like, which can be located within the field of view of the motion sensing module 80, or can temporarily enter the field of view of the motion sensing module 80 and, optionally, can contact (or intersect with) the interactive surface 34.

In a non-limitative embodiment, the motion sensor 82 can include a Kinect™ motion sensor having a camera, an infrared emitter and an infrared depth sensor cooperating to sense the movement of the real within the motion sensor field of view. One skilled in the art will however understand that, in alternative embodiments (not shown), other form, type and/or model of motion sensor 82 can be used, such as sensor using time of Flight (ToF) technology, LIDAR technology, sensor using stereo technology, etc. Hence, the motion sensor 82 can include a different combination of components than the camera, infrared emitter and infrared depth sensor of the embodiment shown to acquire the data relative to the motion of the real-world elements within the motion sensor field of view, which is required to generate the interaction data representative of the contact between the real-world elements and the interactive surface 34 and/or data representative of the presence of real-world elements within the field of view of the motion sensor(s) 82.

In an embodiment, the motion sensing module 80 can also include any additional software, hardware (memory, processor, etc.), or combination thereof to generate the interaction data relative to a contact between real-world elements and the interactive surface 34 and/or from the data relative to real-world movement of the real-world elements within the motion sensor field of view thereof. One skilled in the art will however understand that, in an alternative embodiment, raw data relative to motion of the real-world element within the field of view of the motion sensing module 80 can also be transferred to the control unit 40, with the control unit 40 including the software, hardware, or combination thereof to generate the interaction data relative to the contact between the real-world elements and the interactive surface 34. In an embodiment, the motion sensing module 80 communicates the generated interaction data (or the raw data relative to motion of the real-world element within the field of view of the motion sensing module 80) to the control unit 40 in real-time. For the sake of clarity, in the following description, only reference to the embodiment where the interaction data is generated at the motion sensing module 80 and transferred to the control unit 40 will be made, keeping in mind that alternatively, the interaction data can be generated at the control unit 40, based on the data relative to motion of the real-world element within the field of view of the motion sensing module 80 received therefrom.

In an embodiment, the motion sensing module 80 allows the generation of interaction data, without requiring any sensors being mounted on the corresponding wall 33 of the room 32. In other words, the motion sensing module 80 is mounted to the interactive game portable unit 20 and, more particularly, to the projection head 24, i.e. positioned away from the wall 33 of the room 32 being used as interactive surface 34, with the motion sensor field of view of the motion sensing module 80 being directed towards the wall 33 of the room 32 being used as s interactive surface 34. In the embodiment shown, the field of view of the motion sensing module 80 substantially corresponds to a field of view 54 (FIG. 2) of the projection module 50.

For example, and without being limitative, in an embodiment, the motion sensing module 80 can be configured to detect contacts between balls and the interactive surface 34 (i.e. the motion sensing module 80 is configured to capture the exact position of contact of each one of the balls with the interactive surface 34). One skilled in the art will understand that, in an alternative embodiment, interactions between the physical world and the interactive surface 34, different from the above-mentioned ball contact, can also be detected by the motion sensing module 80 (e.g. a user touching the interactive surface 34, a contact between an object different from a ball and the interactive surface 34, etc.), with the generated interaction data being subsequently transferred from the motion sensing module 80 to the control unit 40.

As will be described in more details below, the control unit 40 can receive the interaction data as user input from the user within the interactive game and perform processing of the interaction data to subsequently control the projection module 50, lighting module 60 and/or sound module 70 to implement the gameplay of the interactive game in accordance with the interaction data received as user input from the motion sensing module 80 (i.e. to generate the data relative to the graphics, lighting and sound to be outputted to the user to allow subsequent user interaction and representing the evolution of the user in the game being played in accordance with the game plot). In the course of the present application, the term “gameplay” is used to refer to the way the game is played and includes the game plot defined by the evolutive sequence of action defining the interactive game and which the player goes through in the game, as the action of the game evolves. Hence, in the present application, the implementation of the “gameplay” encompasses the determination of the specific graphics, lighting and/or sound to be outputted in accordance with the game plot to provide the desired immersive and interactive experience to the players.

The control unit 40 is configured to control at least one of the projection module 50, the lighting module 60 and the sound module 70 in real-time, based on the interaction data, in order to provide an interactive game experience.

In an embodiment, the control unit 40 can run a game engine configured to implement a predetermined gameplay, based on user interactions (or user inputs) as defined by the interaction data input and output the data relative to the corresponding graphics, lighting and/or sound. The game engine can be stored in the memory of the control unit 40 and can include the necessary components to generate the required output instructions for implementing the gameplay (or game logic) (e.g. the graphic display, lighting, sound, etc. required to allow the user to interact and play the game). In an embodiment, the game engine includes, for example and without being limitative, a main game engine implementing the gameplay instructions, a rendering engine generating the required graphic instructions, an audio engine generating the required audio instructions, a lighting engine generating the required lighting instructions, a physics engine, etc. In other words, the game engine generates graphic instructions, lighting instructions and/or acoustic instructions, for the control unit 40 to control the output of the projection module 50, the lighting module 60 and/or the sound module 70 respectively, in accordance with the implementation of the gameplay of an interactive game. One skilled in the art will understand that, in an embodiment, several different interactive games can be played using the interactive game portable unit 20, each interactive game having its own gameplay parameters. In an embodiment, the control unit 40 can access a database including gameplay information regarding the corresponding interactive game.

In an embodiment, the control unit 40 receives the interaction data from the motion sensing module 80 in real-time and generates and transmits output instructions to control at least one of the projection module 50, the lighting module 60 and the sound module 70 also in real-time. As mentioned above, in an alternative embodiment, the control unit 40 can also receive raw data relative to real-world movement within the motion sensor field of view, with the control unit 40 processing the data to generate the interaction data and subsequently generating and transmitting output instructions to control at least one of the projection module 50, the lighting module 60 and the sound module 70 in real-time in order to provide the desired interactive experience to the user.

In view of the above, in an embodiment, the control unit 40 generates graphic instructions as output to be transmitted to the projection module 50 to project graphics (i.e. 2D or 3D graphics) on the interactive surface 34. In an embodiment, the projection module 50 includes a projector 52 (FIG. 3) having the projector field of view 54 (FIG. 2) intersecting with the interactive surface 34, to display the desired graphics on the interactive surface 34. One skilled in the art will understand that, in an alternative embodiment, the control unit 40 can include more than one projector 52 or other display devices controlled by the control unit 40 and capable of displaying graphics on the interactive surface 34. As mentioned above, the graphic instructions relative to the graphics to be displayed by the projection module 50 result from the processing of the interaction data generated using the motion sensing module 80, thereby producing an interactive graphic display for the users. In other words, the graphic instructions are generated based on the interaction data, such that the graphic instructions are dependent of the real-world element contacting the interactive surface 34, thereby providing the interactivity between the real-world actions and providing the evolution of the interactive game.

In FIG. 11, the video projector 52 has been removed to expose other components contained in the projector head 24, including speakers 72, which are part of the high frequency sub-module 70b of the sound module, lights, a camera, a power supply, DIN rail for power distribution, a portion of the control unit, and a PCB for light management.

In an embodiment, the control unit 40 also generates lighting instructions as output to be transmitted to the lighting module 60, to illuminate the room 32 in which the interactive game is played. The lighting module 60 has an illumination span which can cover at least a portion of the room 32 in order not to substantially impede on the quality and contrast of the graphics projected by the projection module 50 on the interactive surface 34. For example and without being limitative, in an embodiment where the interactive surface 34 extends along a surface of a wall 33 of the room 32, the illumination span of the lighting module 60 is substantially limited to illumination of the floor 36 of the room 32, in order to minimize the negative incidence of the lighting provided by the lighting module 60 on the graphics projected by the projection module 50 on the interactive surface 34.

In an embodiment, the lighting module 60 can include a plurality of stage lighting instruments 62 (or stage lighting fixtures) (FIGS. 9 and 10) operating simultaneously and used in combination to illuminate the desired section of the room 32 in which the interactive game is played, in accordance with the lighting instructions. For example, and without being limitative, in an embodiment, the lighting module 60 comprises a plurality of lightning units 62, each one including three lights, mostly located on the lower face 97 of the casing 99. It is appreciated that the quantity, the configuration, and the location of the lightning units can vary from the embodiment shown. The lightning units 62 can be solely static light fixtures, solely moving light fixtures or a combination of moving light fixtures and static light fixtures cooperating to provide the lighting of the corresponding section of the room 32.

In an embodiment, each one of the lightning units 62 of the lighting module 60 can be independently controllable in accordance with the output lighting instructions produced by the control unit 40 (i.e. the type, color, intensity, and/or direction etc. of a light beam produced by each lightning units of the lighting module 60 can be controlled independently). In other words, the lighting instructions produced by the control unit 40 can relate to the lighting to be produced by each one of the lightning units 62 of the lighting module 60 independently.

The independent control of the plurality of lightning units can therefore be used to vary the colors and/or intensity of the lighting and/or display animated lighting sequences including, for example and without being limitative, targeted color change, lighting of specific zones, punctual lighting effects, etc., which highly enhance the immersive experience of the interactive game, in the room 32.

It is appreciated that different lighting control protocols allowing control of each one of the stage lighting instruments 62 can be used.

In an embodiment, the illumination provided by the lighting module 60, according to the lighting instructions generated by the control unit 40, results from processing of the interaction data generated using the motion sensing module 80, thereby producing an interactive illumination for the users. In other words, the lighting instructions are generated based on processing of the interaction data, such that the lighting instructions are dependent on the real-world events related to the real-world elements contacting the interactive surface 34 and/or the presence of real-world events within the field of view of the motion sensor(s) 82, thereby providing the interactivity between the real-world actions and the illumination provided by the lighting module 60.

In an alternative embodiment, the illumination provided by the lighting module 60, according to the lighting instructions generated by the control unit 40, can be independent from the interaction data generated using the motion sensing module 80, i.e. the lighting instructions generated by the control unit 40 can be predetermined and be independent from the interactions of the real-world element with the interactive surface 34. In such an embodiment, there is therefore no sync between the graphics projected by the projection module 50 (according to the graphic instructions output generated by the control unit 40) and the illumination provided by the lighting module 60 (according to the lighting instructions output generated by the control unit 40), while still providing an immersive experience where graphics and illumination are provided in an interactive game played by users in a large room 32.

In an embodiment, the control unit 40 also generates acoustic instructions as output to be transmitted to the sound module 70, to play sounds. In an embodiment, the sound module 70 includes a plurality of speakers 72 (FIG. 10) which are used to play the sounds. In the course of the present description the term “sounds” is used to refer to any emitted vibrations (or propagated soundwave) that can be heard and interpreted when reaching a person's ear, such as, for example, individual noises, music, etc.

The control unit 40 is operatively connected to the low frequency sub-module 70a, located in the central unit 26, and the high frequency sub-module 70b, located in the casing 99 of the projection head 24.

Once again, in an embodiment, the acoustic instructions relative to the sounds to be played by the sound module 70 result from processing of the interaction data generated using the motion sensing module 80, thereby producing an interactive auditive environment for the users. In other words, the acoustic instructions are generated based on the interaction data, indicates which that the acoustic instructions are dependent on the real-world events related to the real-world elements contacting the interactive surface 34 and/or the presence of real-world elements within the field of view of the motion sensor(s) 82, thereby providing the interactivity between the real-world actions and the sounds played by the interactive game portable unit 20. It is appreciated that, in an alternative embodiment, the acoustic instructions can be independent on the real-world events related to the real-world elements contacting the interactive surface 34 and/or the presence of real-world elements within the field of view of the motion sensor(s) 82.

In view of the above, in an embodiment, the control unit 40 can synchronize the graphic projected by the projection module 50, the illumination provided by the lighting module 60 and the sound played by the sound module 70, to provide an immersive experience where the graphics, the illumination and the sounds are complementary and coordinated to match the implementation of the gameplay of the interactive game, as the game progresses. As mentioned above, one skilled in the art will however understand that, in an embodiment, the interactive game portable unit 20 can be free of sound module 70, with the immersive experience being rather provided by the combination of the graphics and the illumination being complementary and coordinated to match the implementation of the gameplay of the interactive game.

In the above description, an embodiment is an example or implementation of the inventions. The various appearances of “one embodiment,” “an embodiment” or “some embodiments” do not necessarily all refer to the same embodiments. Furthermore, although various features of the invention may be described in the context of a single embodiment, the features may also be provided separately or in any suitable combination. Conversely, although the invention may be described herein in the context of separate embodiments for clarity, the invention may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

Furthermore, it is to be understood that the invention can be carried out or practiced in various ways and that the invention can be implemented in embodiments other than the ones outlined in the description above. The descriptions, examples, methods and materials presented in the claims and the specification are not to be construed as limiting but rather as illustrative only.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. An interactive game portable unit comprising:
a base including an extendable shaft translatable between a compacted configuration and an extended configuration wherein the extendable shaft extends outwardly;
a projection head mounted to a distal end of the extendable shaft and translatable therewith; and
a pneumatic actuator operatively connected to the extendable shaft and activable to configure the extendable shaft between the compacted configuration and the extended configuration.

2. The interactive game portable unit as claimed in claim 1, wherein the base comprises a central unit defining a chamber and the pneumatic actuator is at least partially contained in the chamber.

3. The interactive game portable unit as claimed in claim 1, wherein the extendable shaft is a telescopic shaft.

4. The interactive game portable unit as claimed in claim 2, wherein, in the extended configuration of the extendable shaft, a length of the extendable shaft protruding outwardly of the central unit is longer than a height of the central unit.

5. The interactive game portable unit as claim 1, wherein the projection head comprises a coupling receiving recess and the interactive game portable unit further comprises a head engaging coupling mounted to the distal end of the extendable shaft and engageable in the coupling receiving recess to detachably mount the projection head to the distal end of the extendable shaft.

6. The interactive game portable unit as claimed in claim 5, wherein each one of the coupling receiving recess and the head engaging coupling comprises an insertion section having a tapered profile and a coupling section wider than the coupling section.

7. The interactive game portable unit as claimed in claim 5, wherein the projection head comprises function connectors and/or function ports exposed in the coupling receiving recess and the head engaging coupling comprises function connectors and/or function ports complementary to and couplable with the function connectors and/or function ports of the projection head when the head engaging coupling is inserted in the coupling receiving recess of the projection head.

8. The interactive game portable unit as claimed in claim 7, wherein the head engaging coupling further comprises a function connector support having the function connectors and/or function ports mounted thereto and the function connector support is selectively configurable in a raised configuration and a lowered configuration, wherein, when the head engaging coupling is inserted in the coupling receiving recess of the projection head and the function connector support is configured in the raised configuration, the function connectors and/or function ports of the projection head are coupled with the function connectors and/or function ports of the head engaging coupling and, when the function connector support is configured in the lowered configuration, the function connectors and/or function ports of the projection head and the function connectors and/or function ports of the head engaging coupling are uncoupled.

9. The interactive game portable unit as claimed in claim 8, further comprising a connector support translation assembly connected to the function connector support and activable to translate the function connector support between the raised configuration and the lowered configuration and wherein the function connector support comprises a biasing member biasing the function connector support in the lowered configuration.

10. The interactive game portable unit as claimed in claim 9, wherein the connector support translation assembly is operatively connected to the pneumatic actuator.

11. The interactive game portable unit as claimed in claim 1, further comprising a pressure sensor and a control unit, the pressure sensor monitoring air pressure inside an air conduit connecting the pneumatic actuator to the extendable shaft and being in data communication with the control unit to compare the monitored air pressure to at least one air pressure threshold indicative of an obstacle being met while raising or lowering the extendable shaft.

12. An interactive game portable unit comprising:
a base including an extendable shaft translatable between a compacted configuration and an extended configuration, the base comprising a central unit and a plurality of deployable legs mounted to the central unit, the deployable legs being selectively configurable in a compacted configuration and a deployed configuration, wherein, in the compacted configuration of the deployable legs, the base is supported on a floor at least partially by the central unit and, in the deployed configuration of the deployable legs, the base is supported on the floor by the deployable legs with the central unit being spaced-apart from the floor; and
a projection head mounted to a distal end of the extendable shaft and translatable therewith, wherein the extendable shaft protrudes outwardly of the central unit in the extended configuration.

13. The interactive game portable unit as claimed in claim 12, wherein the deployable legs extend adjacent and substantially parallel to the central unit in the compacted configuration.

14. The interactive game portable unit as claimed in claim 12, wherein the deployable legs are pivotally mounted to an upper portion of the central unit and a lower section of the deployable legs is spaced-apart from the central unit in the deployed configuration.

15. The interactive game portable unit as claimed in claim 12, wherein the extendable shaft is configurable in the extended configuration solely when the deployable legs are configured in the deployed configuration.

16. The interactive game portable unit as claimed in any one of claim 12, wherein the deployable legs are configurable in the compacted configuration solely if the extendable shaft is configured in the compacted configuration.

17. The interactive game portable unit as claimed in any one of claim 12, wherein each one of the deployable legs comprises a material with a low friction coefficient at a lower end thereof.

18. The interactive game portable unit as claimed in any one of claim 12, wherein the extendable shaft is a telescopic shaft and each one of the deployable legs is expandable and compactable in length.

19. The interactive game portable unit as claimed in claim 12, wherein in the compacted configuration of the deployable legs, the base is supported on a floor solely by the central unit, and each one of the deployable legs comprises an outer section pivotally mounted to the upper portion of the central unit and an inner section expandable and compactable in length, the inner section having a portion extending below the outer section at least in the deployed configuration.

20. An interactive game portable unit comprising:
a base including an extendable shaft translatable between a compacted configuration and an extended configuration;
a projection head mounted to a distal end of the extendable shaft and translatable therewith; and
a connector sleeve containing and surrounding a plurality of cables extending between the projection head and the base.

21. The interactive game portable unit as claimed in claim 20, wherein the connector sleeve extends helically around the extendable shaft and is configurable in a compressed configuration when the extendable shaft is configured in the compacted configuration and a stretched configuration when the extendable shaft is configured the extended configuration.
